(19) United States
(12) Patent Application Publication
(10) Pub. No.: US 2009/0107764 A1
(43) Pub. Date: Apr. 30, 2009

(54) Lower ladder support

(76) Inventor: Gregory J. Showalter, West Seneca, NY (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/976,885

(22) Filed: Oct. 29, 2007

(51) Int. Cl. E06C 1/00

(52) U.S. Cl. 182/165

(57) ABSTRACT

The lower ladder support is a device adapted for use with a two-railed ladder of the extension type and functions to prevent the ladder from moving, sliding or kicking back during use. The device includes identical support assemblies attached to the rails of the ladder at a lower portion thereof. Each assembly includes a channel, a circular plate having an array of apertures therein, a strap-plate member and rods for attaching the strap-plate, circular plate and channel to a respective rail. The channel is dimensioned to receive and removably retain an elongate, inexpensive, 2×4 wood stock member or similar member therein. The 2×4 member functions as an additional support leg for the ladder.

### BACKGROUND OF THE INVENTION

1. Field of the Invention

The present invention generally relates to support structure. More specifically, the present invention is drawn to a lower ladder support that provides an assembly for stabilizing the lower portion of a two-railed, extension ladder.

2. Description of the Related Art

As normally employed, the upper end of an extension ladder is positioned against a vertical surface such as the wall of a building or the like and the lower end of the ladder is positioned on horizontal surface such as a floor or the ground. Conventionally, the two rails of the ladder contact the vertical and horizontal surfaces establishing two contact points on each surface. Unfortunately, the horizontal surface is often irregular; creating a situation wherein there is only one stable contact point for the ladder on the horizontal surface and thereby making the ladder unstable and unsafe for use. Furthermore, even if the horizontal surface is relatively level, the ladder can slide or slip out and away from the vertical surface or to the right or left while a user is climbing or working at an elevated position, creating situations that can result in serious accidents. The art would certainly welcome an easy-to-use and inexpensive device that would alleviate the dangerous situations described above, thereby reducing the many ladder-caused accidents that occur.

Thus, a lower ladder support solving the aforementioned problems is desired.

### SUMMARY OF THE INVENTION

The present invention is an assembly adapted for use with a two-railed ladder of the extension type and functions to prevent the ladder from moving, sliding or kicking back during use. The ladder support includes identical support assemblies attached to the rails of the ladder at a lower portion thereof. Each assembly comprises a channel, a plate having an array of apertures therein, a strap-plate member and rods for attaching the strap-plate, apertured plate and channel to a respective rail. Each channel is dimensioned to receive and removably retain an elongate, inexpensive, 2×4 wood stock member or similar member therein. The 2×4 members function as additional support legs for the ladder and are adjustable in the channel to steady the ladder even if the ladder is resting on an irregular horizontal surface. Additional 2×4 members can be attached to the above described 2×4 members to further stabilize left and right tip movements.

Accordingly, the invention presents apparatus for providing additional support for an extension ladder. The apparatus is uncomplicated to use, efficient and rugged. The invention provides for an arrangement of improved elements for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a lower ladder support assembly according to the present invention.

FIG. 2 is a partial, perspective view of a lower ladder support assembly according to the present invention.

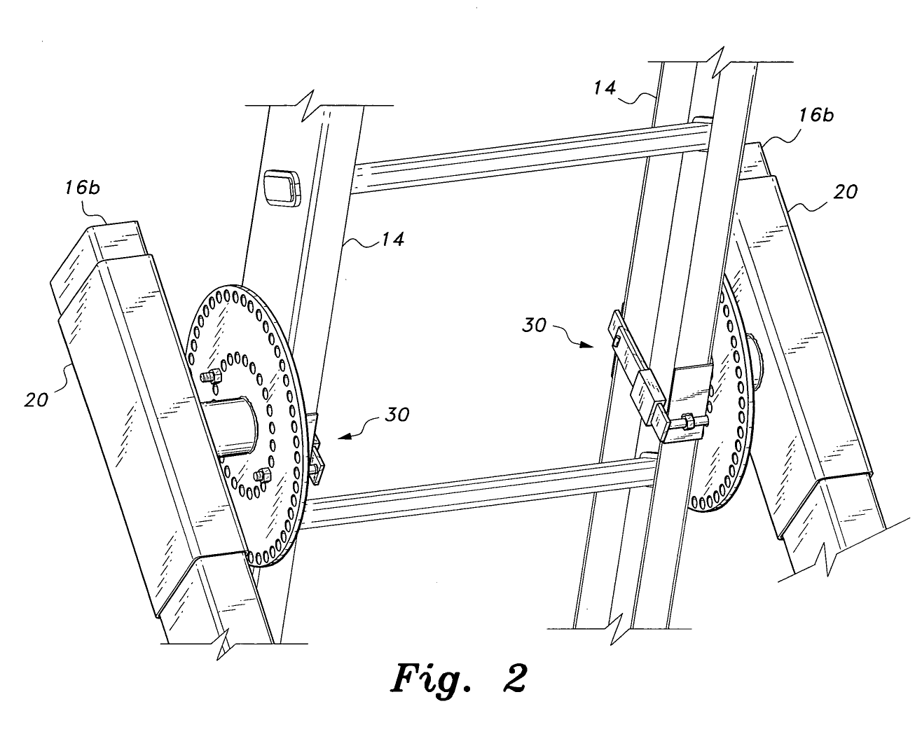

FIG. 3 is a perspective view of a single bracket assembly of a lower ladder support assembly according to the present invention.

FIG. 4 is a perspective view of an adjustable strap of a lower ladder support assembly according to the present invention.

Similar reference characters denote corresponding features consistently throughout the attached drawings.

### DETAILED DESCRIPTION OF THE PREFERRED EMBODIMENT

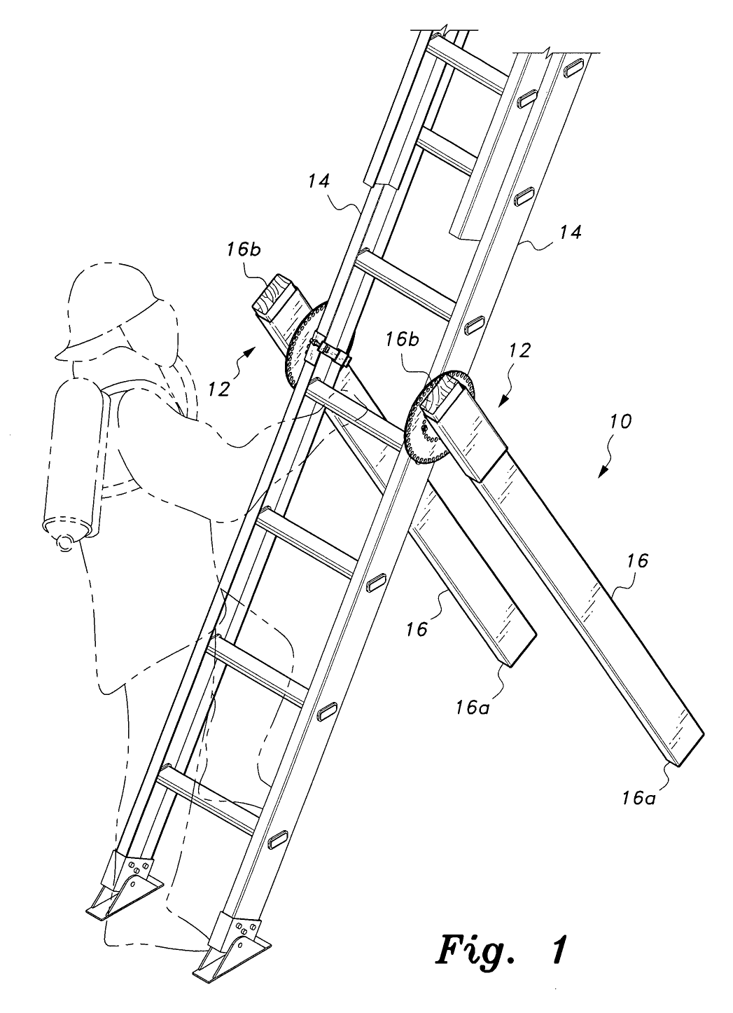

Attention is first directed to FIG. 1, wherein the ladder support assembly of the present invention is generally indicated at 10. Support assembly 10 is mounted on the lower part of an extension ladder and includes respective identical bracket assemblies 12 mounted on respective rails 14 of an extension ladder. Each bracket assembly 12 retains a proximate end of a respective 2×4 stock member 16 therein. The distal ends 16a of stock members 16 engage the ladder horizontal support surface thereby providing additional support structure for the ladder. The proximate ends 16b of members 16 are removably retained in a respective bracket assembly 12. As noted above, the additional support structure prevents the ladder from moving, sliding or kicking back during use.

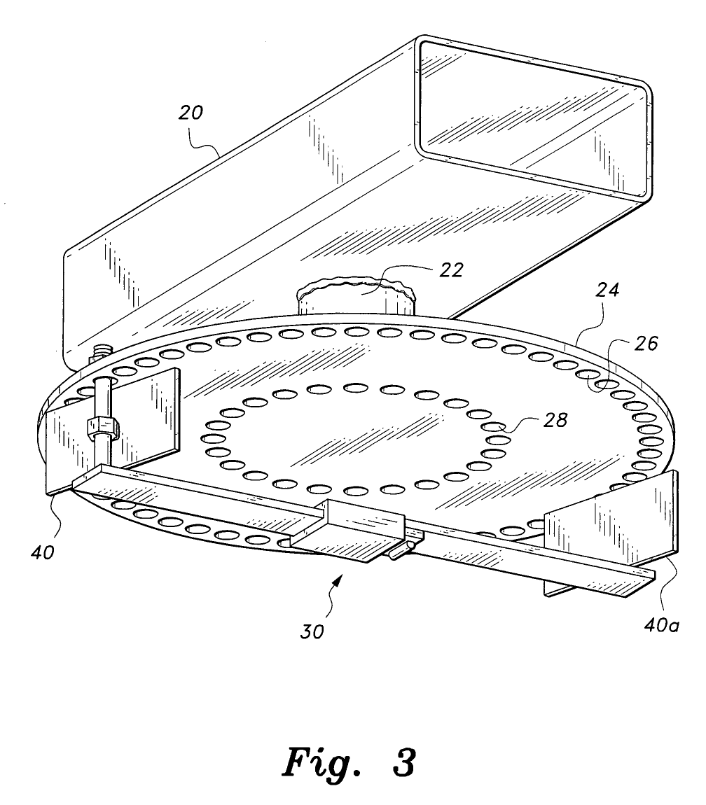

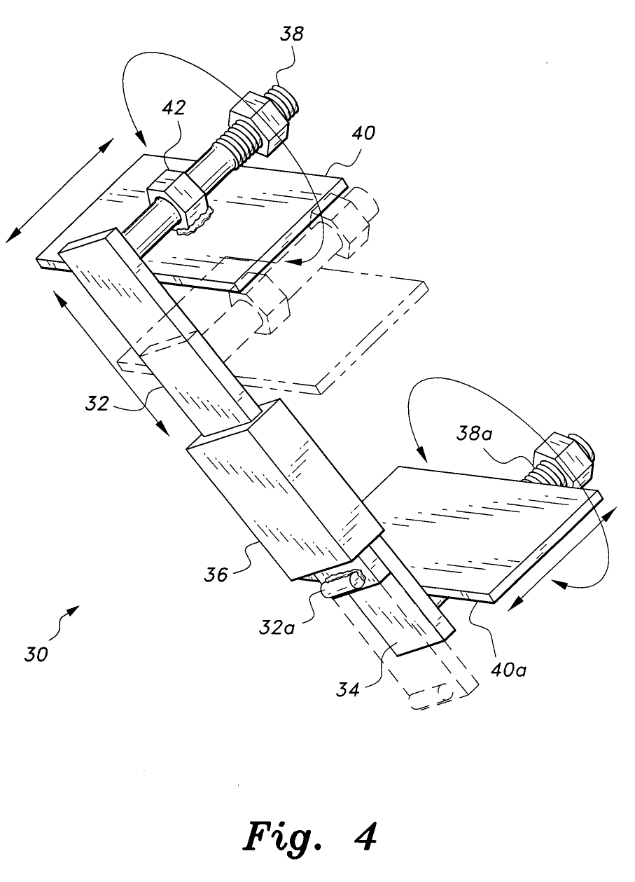

As best seen in FIGS. 3-4, each bracket assembly 12 comprises a channel 20, which channel is open at both ends. Channel 20 is dimensioned to frictionally retain a 2×4 wood stock member therein. A hub 22 has one end attached to a side of channel 20 preferably by welding. The other end of hub 22 terminates in a circular plate 24. Although plate 24 is illustrated and described herein as circular, it should be recognized that the plate could be fabricated in other suitable configurations (hexagonal, octagonal, etc.). An array of concentrically arranged openings 26 and 28 is formed in circular plate 24. Concentric openings 26 and 28 are evenly spaced around the surface of circular plate 24. A strap member 30 is arranged to attach circular plate 24 to the rail of the ladder. Strap member 30 comprises plate members 32, 34 having abutting surfaces arranged for sliding movement relative to each other within collar 36. A stop member 32a is positioned on plate member 32 to limit the adjustability of the plate members. Respective rods 38, 38a are disposed adjacent the ends of the respective plates 32, 34. Respective rail-engaging members 40, 40a are secured on nuts 42 (only one nut shown in FIG. 4). Respective nuts 42 are mounted on respective rods 38, 38a. The nuts have internal diameters larger than the external diameters of the respective rods, whereby to allow the nuts to have free lateral and rotatable (360 degrees) movement.

In use, a respective bracket assembly 12 is attached to each rail 14 of the ladder. The attachment is accomplished by positioning strap 30 on the inner face of the rail so that the rods 38, 38a extend past the edges of the rail and are secured through a set of openings in circular plate 24. Rail engaging members 40, 40a are adjusted to lie flat against the edges of the rail to protect the rail from being degraded by contact with the rods and provide greater braking surface in the event of ladder movement. The 2×4 member 16 is inserted in channel 20 to provide the additional support. Member 16 is retained in channel 20 without the need of additional fasteners. When the ladder is fully extended the innermost array of openings 28 in plate 24 are employed to secure the assembly. When the ladder is retracted, the outermost array of openings 26 is used.

It is to be understood that the present invention is not limited to the embodiment described above, but encompasses any and all embodiments within the scope of the following claims.

I claim:

1. A lower ladder support, comprising:
a channel member having a front face, a rear face, an open top and an open bottom;
a hub having a first end and a second end, the first end being attached to the front face of the channel member,
a plate defining the second end of the hub, an array of openings being formed through the plate; and
a strap member removably attached to the plate.

2. The lower ladder support according to claim 1, further including a pair of rods attached to said strap member for attaching said strap member to said plate.

3. The lower ladder support according to claim 1, wherein the array of openings formed in said plate comprises concentric openings.

4. The lower ladder support according to claim 1, wherein said strap member is adjustable.

5. The lower ladder support according to claim 1, wherein said channel member is dimensioned and configured for frictionally receiving a 2×4 stock wood member therein.

6. A lower ladder support, comprising:
a channel member having a front face, a rear face, an open top and an open bottom;
a hub having a first end and a second end, the first end being attached to the front face of the channel member,
a plate defining the second end of the hub, the plate having an array of concentric openings formed therethrough;
an adjustable strap member removably attached to the plate; and
a pair of rods attached to the strap member for attaching the strap member to the plate.

7. The lower ladder support according to claim 6, further including a respective rail-engaging member freely movably mounted on each of said pair of rods.

8. The lower ladder support according to claim 6, further including a stop member disposed on said adjustable strap member for limiting the adjustability of said strap member.

9. The lower ladder support according to claim 6, wherein said channel member is dimensioned and configured for frictionally receiving a 2×4 stock wood member therein.

10. A lower ladder support, comprising:
a channel member having a front face, a rear face, an open top and an open bottom, the channel member being dimensioned and configured for frictionally receiving a 2×4 stock wood member therein;
a hub having a first end and a second end, the first end being attached to the front face of the channel member,
a circular plate defining the second end of the hub, the circular plate having an array of concentric openings formed therethrough;
an adjustable strap member removably attached to the circular plate;
a stop member disposed on the adjustable strap member to limit the adjustability of said strap member; and
a pair of rods attached to the strap member for attaching the strap member to the circular plate.

11. The lower ladder support according to claim 10, further including a respective rail-engaging member freely moveably mounted on each of said pair of rods.

12. The lower ladder support according to claim 10, further including a respective rail-engaging member freely moveably mounted on each of said pair of rods, each of the respective rail-engaging members being attached to a respective nut, wherein each respective nut is mounted on a respective rod for free lateral and rotatable movement thereon.

13. The lower ladder support according to claim 10, further including a respective rail-engaging member adjustably mounted on each of said pair of rods, wherein each of the respective rail-engaging members is a plate.

14. The lower ladder support according to claim 10, further including a respective rail-engaging member freely, mounted on each of said pair of rods, each of the respective rail-engaging members being a plate attached to a respective nut wherein each respective nut is mounted on a respective rod for free lateral and rotatable movement thereon.
